(19) United States
(12) Patent Application Publication
(10) Pub. No.: US 2009/0210350 A1
(43) Pub. Date: Aug. 20, 2009

(54) Method and a system

(76) Inventor: Adam Immanuel Orre, Solna (SE)

Correspondence Address: ADAM IMMANUEL ORRE, MISTELVAGEN 5, 18435 AKERSBERGA, SE

(21) Appl. No.: 11/078,671

(22) Filed: Mar. 10, 2005

Related U.S. Application Data
(60) Provisional application No. 60/552,089, filed on Mar. 10, 2004.

(51) Int. Cl. G06Q 30/00; G06Q 50/00; G06F 17/00

(52) U.S. Cl. 705/80; 700/107

(57) ABSTRACT

The present invention relates to a method and a system for manufacturing of products whose design and/or price are specified individually by a set of independent customers. A customer profile of at least one customer of the set is registered through inputting customer specific data into a customer database. A manufacturer profile of at least one manufacturer is registered through inputting manufacturer specific data into a manufacturer database. A desired product design is specified through a design interface and stored in a design database. Potentially similar product designs stored in the design database are then clustered according to clustering parameters. A matching of potential manufacturers for manufacturing of the clustered similar products is performed in the manufacturer database according to scoring parameters. Thereafter an offer for product manufacturing is sent to manufacturers scored in the database according to the scoring parameters and contracts are initialized for production and deliverance of a certain amount of the products to their respective customers for manufacturers accepting the offer.

### TECHNICAL FIELD

The present invention pertains to a method and system for manufacturing of products whose design is specified individually by a set of independent customers through means of connected customer, manufacturer and product design databases.

### BACKGROUND ART

Design and manufacturing of products which do not have predefined design templates involves tedious and expensive specification work and high manufacturing costs.

It is for example currently possible to customize, “build”, an automobile according to a personally set prize and order the same online an Internet webpage. However, different customers my have different willingness to pay for a certain product feature. Prize differentiation and bundling are rigid schemes for catching different willingness to pay.

The present invention through characteristics of the independent claims intends to solve these problems.

### SUMMARY OF THE DISCLOSED INVENTION

The present invention relates to a method and system for manufacturing of products whose design is specified individually by a set of independent customers.

One aspect of the invention is to provide such a method and system enabling a manufacturing of customer designed products where both product cost and manufacturing time is optimized.

To achieve aims and objectives the present invention provides a method for manufacturing of products whose design is specified individually by a set of independent customers. The method comprises the steps of:

registering a customer profile of at least one customer of the set through inputting customer specific data into a customer database;

registering a manufacturer profile of at least one manufacturer through inputting manufacturer specific data into a manufacturer database;

specifying a desired product design through a design interface means and storing the design in a design database;

clustering of potentially similar product designs stored in said design database according to clustering parameters;

searching and scoring of potential manufacturers for manufacturing of the clustered similar products in the manufacturer database according to scoring parameters; and

wherein an offer for product manufacturing is sent to manufacturers scored in the database according to the scoring parameters and contracts are initialized for production and deliverance of a certain amount of the products to their respective customers for manufacturers accepting the offer

In one embodiment of the method according to the present invention, clustering parameters are related to at least one of product size, product shape, product material and product type.

In another embodiment of the method according to the present invention, scoring parameters are at least one of product type, product prize, time limit for product deliverance and product manufacturing location.

In a further embodiment of the method according to the present invention, the design interface means is based on at least one of free text, dedicated design language and dedicated design tools.

In yet another embodiment of the method according to the present invention, a maximum price for a product is specified and stored in the design database.

A further embodiment of the method according to the present invention comprises that a maximum time limit for the maximum price to be valid is specified and stored in the design database.

Yet a further embodiment of the method according to the present invention comprises that the manufacturer specific data include at least one of production capability data and production location data

Furthermore the present invention sets forth a system for manufacturing of products whose design is specified individually by a set of independent customers. The system comprises:

a means for registering a customer profile of at least one customer of the set through inputting customer specific data into a customer database;

a means for registering a manufacturer profile of at least one manufacturer through inputting manufacturer specific data into a manufacturer database;

a design interface means for specifying a desired product design and storage in a design database;

a clustering means for clustering of potentially similar product designs stored in said design database according to clustering parameters;

matching means for searching and scoring of potential manufacturers for manufacturing of said clustered similar products in said manufacturer database according to scoring parameters; and

wherein an offer for product manufacturing is sent to manufacturers matching said scoring parameters in said manufacturer database and contracts are initialized between customers of the clustered products and the manufacturers accepting said offer, wherein the contract stipulates at least one of an amount of products to be delivered, product cost and time limit for the product deliverance.

One embodiment of the system according to the invention comprises a contract means for establishing said contracts according to requisites agreed upon by said manufacturers and customers.

Another embodiment of the system according to the invention further comprises a negotiation means for providing a manufacturer versus customer negotiation support for reaching an agreement between contracting parties.

### BRIEF DESCRIPTION OF THE DRAWINGS

Henceforth reference is had to the attached figures for a better understanding of the present invention and its examples and embodiments, wherein:

FIG. 1 schematically in a flowchart shows a registration of customer data into a customer database;

FIG. 2 schematically in a flowchart shows a registration of manufacturer data into a manufacturer database.

FIG. 3 in a flowchart illustrates an embodiment of the invention in which a customer specifies a desired product design which is stored into the design data base;

FIG. 4 in a flowchart illustrates a flow of events beginning with a clustering of potential product designs leading to a produced and delivered product.

### DETAILED DESCRIPTION OF PREFERRED EMBODIMENTS

The present invention sets forth method and a system for manufacturing of products whose design and/or prize are specified individually by a set of independent customers.

A customer profile of at least one customer of the set is registered through inputting customer specific data into a customer database. A manufacturer profile of at least one manufacturer is registered through inputting manufacturer specific data into a manufacturer database. A desired product design is specified through a design interface and stored in a design database. Potentially similar product designs stored in the design database are then clustered according to clustering parameters. A matching of potential manufacturers for manufacturing of the clustered similar products is performed in the manufacturer database according to scoring parameters. Thereafter an offer for product manufacturing is sent to manufacturers scored in the database according to the scoring parameters and contracts are initialized for production and deliverance of a certain amount of the products to their respective customers for manufacturers accepting the offer.

The actual specification details and prize may differ between different customers. The system keeps a data base of the customers and the design requirements specified by the customers. The data base also contains data about registered manufacturers and keeps updated information about each manufacturer's abilities to produce certain types of products. Each customer who wants a specific product with specific properties uses a design interface alternatively a specific description language to specify the desired properties of the desired product. A design specified may either be new, identical to an earlier specified design or build upon earlier designs.

The customer also specifies the maximum prize the customer is prepared to pay for this product, and may also specify the maximum time period within which this desired product is wanted. The customer may also specify the maximum time period within which the maximum prize specified is valid, alternatively specify how the maximum prize may develop over time. As long as each individual customer has not been offered any product by any manufacturer the individual customer may change the desired design or the maximum prize the specific customer is prepared to pay.

Through the system, similarity measures are used to collect groups or clusters of customers who are close from which an average product design can be extracted. A group may consist of one to an arbitrary amount of customers. The calculation of the average product design may be weighted according to each customer's maximum prize level.

The system may then through inherent means score the potential manufacturers stored in the data base from a logistic viewpoint, the desired prize level and earlier viability scores based upon how this manufacturer could keep contracts.

Manufacturers or entrepreneurs who are looking for customers may search the data base for potential products which are within the range of products this manufacturer is able to produce.

The system can also assist the manufacturer or entrepreneur in finding manufacturers who can collaborate in producing a certain desired product, based upon each registered manufacturer's profile.

When a manufacturer or a set of collaborating manufacturers have found that they are able to produce a certain product with a reasonable cost profit balance, the system helps the manufacturer or entrepreneur to negotiate with the set of customers who want a certain product.

When the negotiation about design properties is made the system assists the manufacturers in setting up contracts and payments with the customers and the manufacturers.

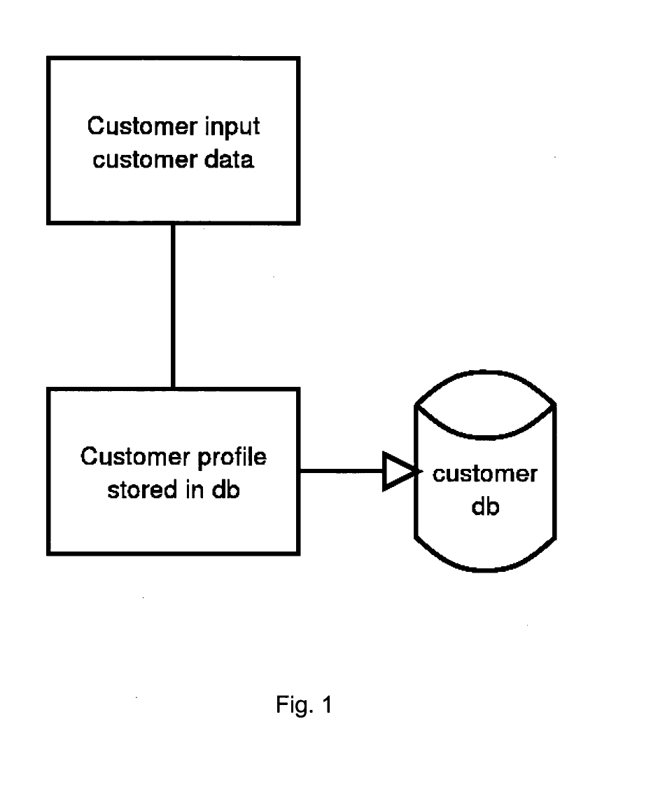

In FIG. 1 is schematically illustrated a registration of customer data into a customer database.

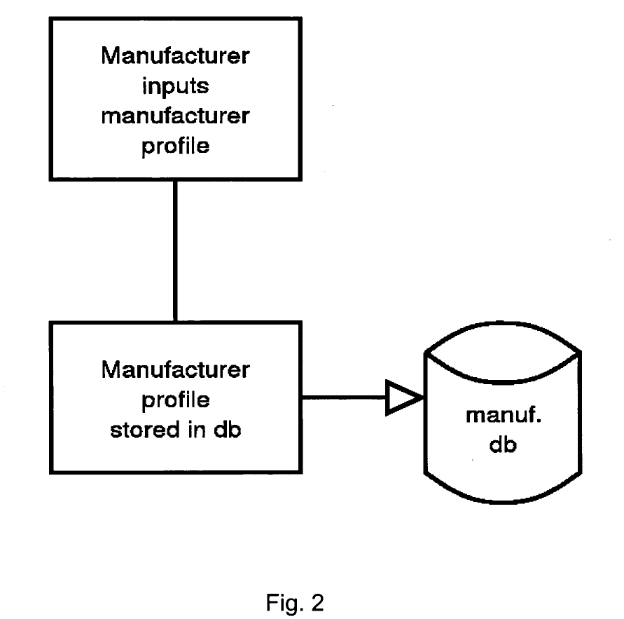

In FIG. 2 is schematically illustrated a registration of manufacturer data into a manufacturer database.

### Components of the System

Database of registered customers.

Database of registered manufacturer profiles.

Database of customer design specifications.

Clustering mechanism for designs.

Scoring system for manufacturers' vs. designs.

Scoring system of products vs. manufacturers.

Manufacturer vs. customers negotiation system.

Manufacturer vs. customers contract system.

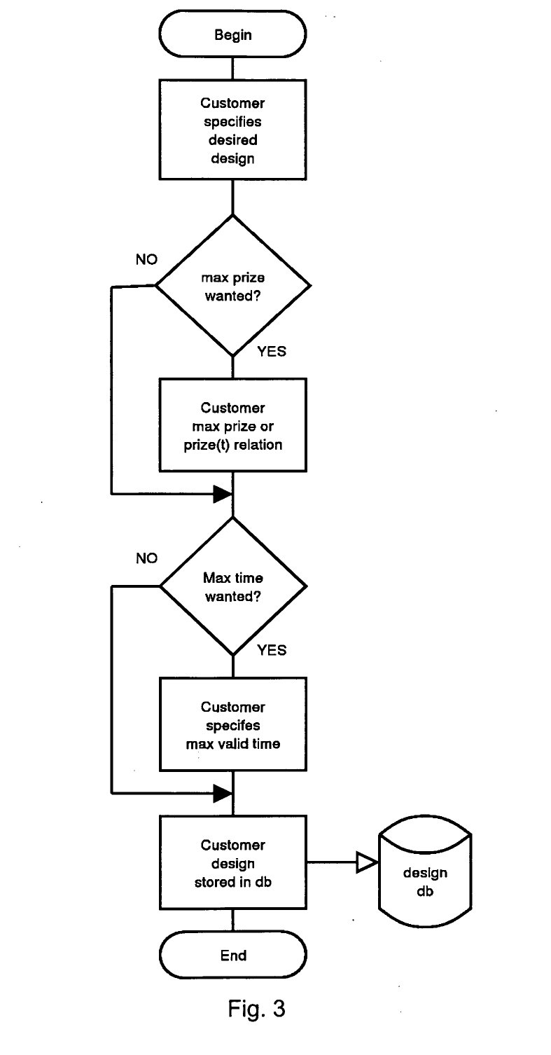

In FIG. 3, an embodiment of the invention is shown where a customer selects from a variety of different interfaces such as free text, dedicated design languages or dedicated design tools to specify a desired design which is stored into the design data base.

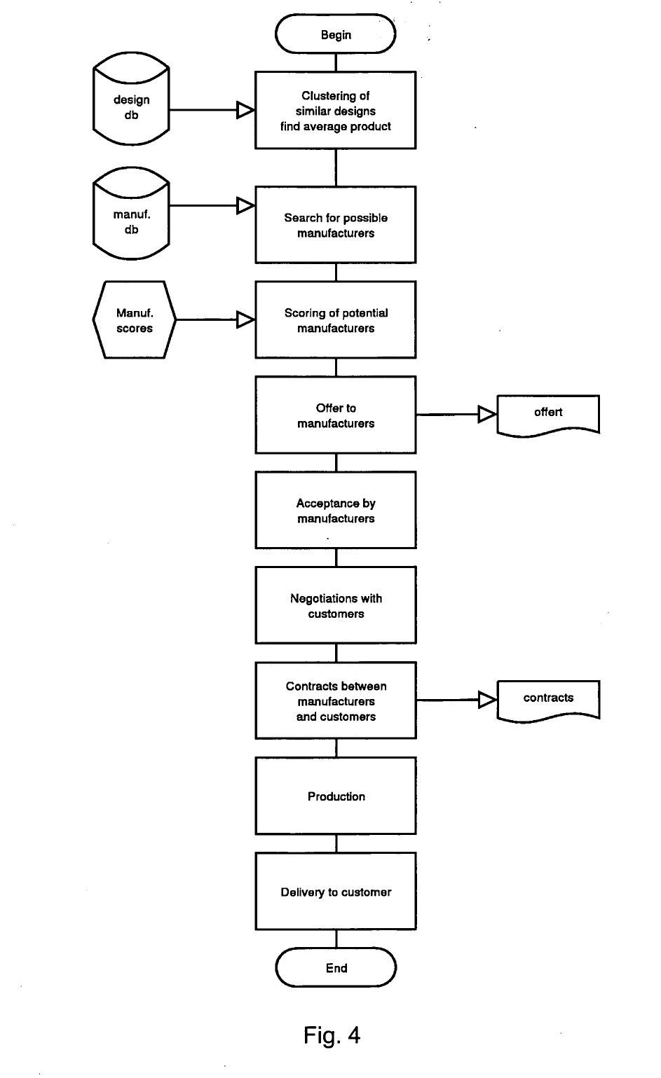

FIG. 4 illustrates an embodiment of the invention where a clustering of potential product designs initially is performed. A scoring or matching of potential manufacturers is then performed and offers are sent to different manufacturers scored. These manufacturers then accept, possibly after some negotiation with the customers, supported by means of the system. Contracts are then initialized or established through means of the system and the product can be produced and delivered accordingly.

Means mentioned in the present description can be software means, hardware means or a combination of both.

### EXAMPLES

Exhaustive examples of implementation is not possible to give as the design languages used are different for different areas as the final product may be composed of parts which are from different areas as:

1. mechanics and optics

2. electronics/optronics/logicomechanics/mechatronics

3. material technology

4. medicine/molecular biology

5. chemistry/molecular composition

6. information processing

7. software and software systems

Specification of Design and Results from Clustering:

The design may be specified by free text, including structured text like XML/SGML, dedicated design languages for particular areas or by using dedicated design tools.

The simplest form of input is given by free text such as abstracts and keywords. An abstract is used for instance when specifying a project, like a research project, or as a free form to specify a product which may come from any combination of the areas above. A textual or other form of description of the desired product may need different ways of describing different aspects of the product. These may be aspects like topology, in for e.g. mechanical, mechatronic, optical, software and molecular designs. It may also be aspects like desired ranges for product parts, like effect, voltage, frequency, bandwidth, size, energy capacity etc.

When textual abstracts are given as input, the system first looks for features in the set of given abstracts, to make the abstracts easy comparable by linear scoring/distance methods. Clustering is used to find groups of abstracts which are close.

A specific customer design may be a member of several clusters with varying probabilities. Keywords used in the design can be used to explicitly control whether a specific design belongs to a specific cluster or not, by specifying “not” before a keyword.

Example Using Keyword Modifiers:

In the abstract for a research project it may be specified:

Abstract:

“To evaluate possible methods for brain to brain communication without using external devices, possibly using programmable nano devices which can identify the interesting states of the brain, and forward these to a specified set of brains.

Keywords:

brain, communication, not radio.

The keyword “not radio” above implies that clusters where radio technology is specified will be excluded.

Example on Clustering Combined with Unsupervised Pattern Recognition by Maximizing the Likelihood for Items to Occur Together:

As an example of a mechanical design, different customers may specify:

“Wearable aircleaner.”

“Wearable aircleaner with transparent mask.”

“Portable aircleaner with transparent mask and HEPA filter.”

“Wearable aircleaner with HEPA filter.”

“Portable aircleaner with recharchable batteries.”

“Portable aircleanear with HEPA filter and rechargable batteries.”

“Wearable aircleaner with invisible mask and HEPA filter.”

“Portable airclearner with replaceable filters.”

Some preprocessing is first done, to find synonyms and features (i.e. parts which always occur together). For instance “wearable” and “portable” have similar meanings, but the terms can also be graded like saying “wearable”>“portable” in the scoring process. That is “wearable” is more worth than “portable”.

When these designs are clustered most of them will be rather far from the cluster center, which is normally the average of the included terms. Therefore an unsupervised pattern recognizer, as a Bayesian classifier which is trained with terms from the cluster, and iterated by feeding the classifier outputs back to its inputs until stability is reached, will find at least one attractor. This attractor constitutes a maxima of the likelihood for the parts of the components of this cluster to occur together. The final results will then look like (order of component part is not given by the classifier)

“Wearable aircleaner with rechargeable batteries, with HEPA filter, with transparent mask.”

Mechanic, mechatronic, molecular, designs may also be supported by the designer by topological descriptions, which in their simplest form may appear as:

“filter connected to air intake”

“fan connected to filter with tube”

“tube is connected to mask”

These topological descriptions are also clustered in a similar way and paired with the part descriptions.

Designs may be described in dedicated modeling languages for each type of design, for mechanical, optical, molecular and related types of designs the parts are specified by their desired properties. Not usually by giving explicit components but by specifying what ranges, what performance, what dimensions etc are desirable. These designs are clustered and preprocessed until a conceptual design is achieved. These conceptual designs can either be transformed into drawings by applied type theory or by entrepreneurs who can act as agents between the product specification and the manufacturers which will produce the actual design.

Example on Product Containing Parts Found as Research Project:

A customer may specify:

“A cure or drug for rare disease muscular dystrophy”

When the system receives this specification, it will first check unfinished research projects. If the design description is close to an unfinished research project the customer is hinted about that there is such a project, and is offered the possibility to sponsor this project.

Example on Using Previous Product Designs as Basis for New Product Specifications:

Each design which once has been identified or manufactured may be used as parts or reference in new designs. Each part or product design will then be available in a wiki like format where the customer can verify that each earlier product referenced in a new design specification fulfills the desired properties. The customer may also get estimates of expected price and expected delivery time for each part based upon earlier manufacturing statistics.

Assume that the design “Wearable aircleaner with rechargeable batteries, with HEPA filter, with transparent mask” above was manufactured and then given the identifier WACHRTM.

A customer may then specify:

“WACHRTM with autostart induced by autodetection of dangerous particles in surrounding air.”

A product design which was not previously manufactured through the system may still be used as a reference in new product designs. In this example a T610 (a Sony-Ericsson mobile manufactured year 2003) is used.

A customer may then specify:

“As T610 with >6 GHz cell like CPU, >4 GB of RAM using user programmable and installable/modifiable operative system with automatic roaming between UMTS/GPRS/802.11 g protocols including ad-hoc routing for 802.11g, with GPS, with fibre optic output to external >1600×1200 display.”

For each of the identifiers, used, which are now uniquely found in the database, the customer is asked to verify each identifier. Here “T610”, “cell CPU”, “GPS” may not be unique identifiers. For instance “cell CPU” may be replaced with a reference to a general CPU specification with certain property conditions, making it easier to match this customer's design with other customer's designs.

In the preprocessing of this design specification the lexical analyzer may find, if “fiber optic display” is defined in the data base, that the desired protocol is not specified and the customer may then get the option to specify e.g “optical 3D DVI” from a selection.

In the example above a previously known, product is used as a reference to a complex part, which implies that the customer does not need to specify any details about this part, which implies that any design has DAG (Directed Acyclic Graph) properties.

Example on Mechatronic Specification Utilizing Component Techniques, but not Necessarily Predefined Components, as Well as Consisting of Several Design Specifications:

“A holographic >1600×1200 display utilizing e.g. micromirror technique like in (Mitsubishi DLP, Texas DMD), producing, in real time, a full color picture, for each eye, at <3 cm from eye, without the need for correction lenses, fed by optical 3D DVI.”

Using Labels for Cross Referencing Within a Design:

Each design specification may consist of several parts. These parts may be referred to by the use of local labels, by assigning a name to each design which may then be cross referenced in the design. Below is an example of a design which uses local labels. As this is in fact a hierarchical description XML or similar would be more relevant, but free text is used here for illustration purpose as it is easier to read.

Abstract:

A communication device partly injected in the users brain which utilizes a transceiver NANOTRANS which communicates with a slave device PHOTOBARRAGE which translates the input/output stream of data with the help of a WEARCOMP which allows the user to directly exchange information brain to brain or brain to computer or with a selected set of remote brains or computers.

Label NANOTRANS:

A device composed of a plethora of molecular devices NANOREC, which are able to transform short photon barrages into local brain activity, and a plethora of molecular devices NANOSEND, which are able to transform local brain activity into short photon barrages.

Label NANOSEND:

A molecular device which uses energy from surrounding ATP and reacts upon specific transmitter substances and transform these into short photon barrages at a specific frequency.

Label NANOREC:

A molecular device which uses energy from the surrounding ATP and reacts upon short photon barrages at specific frequencies and for each barrage received synthesizes a specific amount of transmittor substance which stimulates local brain cells.

Label PHOTOBARRAGE:

A nano electronic device which is sending and receiving on a wide set of frequencies using short photon barrages, which are transformed into an input/output stream of data.

Label WEARCOMP:

A general wearable computer, as specified elsewhere.

General Remarks:

A general design description in free text is seen as a list of components where certain attributes like “with”, “in”, “which”, “uses” etc are used as semantic markers implying that a very simple parser, not requiring natural language understanding, is used.

A topological description may also be specified in text but for topology there are formal languages which are better suited for this, customized for different design areas. A design specification may also be supplied with a drawing or a detailed description in a specific design language for each specific area. As design languages usually are hierarchical such design languages demand less feature detection than free text as the non linear dependencies are already compensated for in the hierarchical structure of the language.

Examples of Design Languages:

This is a non exhaustive list of design languages which may be used for specific areas, apart from the general free text format which is mostly suitable for abstract descriptions.

| | |
|---|---|
| ALGOR | for mechanical design |
| ASML | for software systems designs |
| ASN | for design of communication structures |
| Autocad | for mechanical design |
| Castor | for logicomechanical systems (incl nano) |
| Code V | for optical design |
| CSV | for component specification parameters |
| EDA | for FPGA/ASIC specification |
| EES | for design of mathematical transformations |
| IDEAS | for mechanical design |
| Java | for hardware/software specification |
| Lambda calculus | for software module designs |
| LATMIC | for design of nano lithography |
| LATMIC | for design of nano structured materials |
| LSC | for hardware specification |
| Maple | for design of mathematical |
| | transformations |
| MathCad | for design of mathematical transformations |
| Mathematica | for design of mathematical transformations |
| Matlab | for design of numerical algorithms |
| MechanicalDesktop | for mechanical design |
| MEDLAR | for design of logics/linear/non linear info proc. |
| Mentor | for schematic design |
| MMTK | for molecular modeling/design |
| MSC | for design of communication flows |
| NanoCad | for molecular designs |
| NANOPT | for spec of nano optical devices |
| NASTRAN | for mechanical design |
| Nemo | for design of nanoelectronics |
| Octave | for design of numerical algorithms |
| ODMG | for hardware/software specification |
| Orcad | for schematic design |
| ProEngineer | for mechanical design |
| Prolog | for constraint logic specification |
| pseudo code | for software module designs |
| QSAR | for probabilistic molecular design |
| R | for design of numerical algorithms |
| RSL | for hardware/software specification |
| SDL | for design of communication state protocols |
| SpecC | for hardware specification |
| Spice | for electronic design |
| TTCN | for design of communication verification tests |
| UML | for software system designs |
| Verilog | for FPGA/ASIC specification |
| Verilog | for hardware/software specification and tests |
| VHDL/OVHDL | for design of nano computing devices |
| VHDL/OVHDL | for design of VLSI circuits and other hardware |
| XML/SGML | for generic design specifications |
| ZEMAX | for optical design |

The present invention has been described with non-limiting examples and embodiments. It is the attached set of claims that describe all possible embodiments for a person skilled in the art.

1. A method for manufacturing of products whose design is specified individually by a set of independent customers through an Internet webpage displayed on a computer, comprising the steps of:
registering a customer profile of at least one customer of the set through inputting customer specific data into a customer database;
registering a manufacturer profile of at least one manufacturer through inputting manufacturer specific data into a manufacturer database;
specifying a desired product design through a design interface means and storing said design in a design database;
clustering of potentially similar product designs stored in said design database according to clustering parameters;
searching and scoring of potential manufacturers for manufacturing of said clustered similar product designs in said manufacturer database according to scoring parameters;
sending an offer for product manufacturing to manufacturers scored in the manufacturing database according to said scoring parameters, and
initializing contracts for production and delivery of a certain amount of said products to their respective customers for manufacturers accepting said offer.

2. A method according to claim 1, wherein the clustering parameters are related to at least one of product size, product shape, product material and product type.

3. A method according to claim 1, wherein the scoring parameters are at least one of product type, product price, time limit for product deliverance and product manufacturing location.

4. A method according to claim 1, wherein said design interface means is based on at least one of free text, dedicated design language and dedicated design tools.

5. A method according to claim 1, wherein a maximum price for a product is specified and stored in the design database.

6. A method according to claim 5, wherein a maximum time limit for said maximum price to be valid is specified and stored in the design database.

7. A method according to claim 1, wherein said manufacturer specific data include at least one of production capability data and production location data.

8. A system for manufacturing of products whose design are specified individually by a set of independent customers through an Internet webpage displayed on a computer, comprising:
means for registering a customer profile of at least one customer of the set through inputting customer specific data into a customer database;
means for registering a manufacturer profile of at least one manufacturer through inputting manufacturer specific data into a manufacturer database;
design interface means for specifying a desired product design, wherein a specified design is stored in a design database;
clustering means for clustering of potentially similar product designs stored in said design database according to clustering parameters;
matching means for searching and scoring of potential manufacturers for manufacturing of said clustered similar product designs in said manufacturer database according to scoring parameters; and
wherein an offer for product manufacturing is sent to manufacturers matching said scoring parameters in said manufacturer database and contracts are initialized between customers of the clustered products and the manufacturers accepting said offer, wherein said contracts stipulate at least one of an amount of products to be delivered, production cost and time limit for the product delivery.

9. System according to claim 8, further comprising contract means for establishing said contracts according to requisites agreed upon by said manufacturers and customers.

10. System according to claim 8, further comprising negotiation means for providing a manufacturer versus customer negotiation support for reaching an agreement between contracting parties.
